(19) United States
(12) Patent Application Publication
(10) Pub. No.: US 2004/0048643 A1
(43) Pub. Date: Mar. 11, 2004

(54) Tabletop wargame campaign data management

(76) Inventor: Stefan Wayne Lauter, New South Wales (AU)

Correspondence Address: NOTARO AND MICHALOS, 100 DUTCH HILL ROAD, SUITE 110, ORANGEBURG, NY, 10962-2100, US

(21) Appl. No.: 10/658,064

(22) Filed: Sep. 9, 2003

(30) Foreign Application Priority Data
Sep. 11, 2002 (AU) 2002951338

(51) Int. Cl. A63F 13/00

(52) U.S. Cl. 463/1

(57) ABSTRACT

A method of managing tabletop wargame campaign data includes registering details of each player's forces and details of a campaign between the forces with a management computer, exchanging between the players at least some of the details of the forces and the campaign, updating the details of the forces and the campaign after each player has had an opportunity to input information in relation to their forces, exchanging between the players the updated details of each player's forces and the campaign and advancing a campaign time in one or more discrete time steps until contact is made between opposing forces or a predetermined campaign time is reached. Supply, logistics, order scheduling and synchronization, hierarchies, objectives, geographical features and weariness are also considered. A system, apparatus and computer program for implementing the method are also disclosed.

### FIELD OF THE INVENTION

The invention relates to tabletop wargame campaign data management. In particular, although not exclusively, the invention relates to a system, method, apparatus and computer program for managing tabletop wargame campaign data.

### BACKGROUND TO THE INVENTION

Many tabletop wargames are fought as stand alone tactical battles, although some wargamers have attempted to play a more strategic game simulating a military campaign. However, managing the details of the competing forces including their composition, characteristics and movements and the contacts between the various players' forces can be both complex and time-consuming. Therefore, only the most basic of information has been managed using conventional manual methods. Furthermore, many assumptions that limit the realism of the campaign must be made using conventional manual methods. One area that is very difficult to achieve accuracy is the timing of events in the campaign. Hence, the simulation of military strategies, such as manoeuvre theory, is rarely achieved in a satisfactory manner for tabletop wargamers in a campaign.

The employment of a computer systems and programs have been proposed, but the conventional methods and computer programs in this area have four major shortcomings. Firstly, they simplify the issue of timing by using alternate movement turns for the two players, removing a realistic representation of unit's location in time, especially where mobility is a key factor. Secondly, they divide a map into a series of grid cells with the position of a unit based on the grid cell it occupies, thus limiting the positions that a unit may occupy. Thirdly, they do not allow military hierarchies or task forces to be represented. Consequently only one level of unit structure can be controlled. Finally, these attempts do not allow for objectives or for success or failure in achieving them to contribute to the calculation of the result of the campaign.

Hence, there is a need for a system, method and/or apparatus for simulating wargaming that ameliorates one or more of the aforementioned problems associated with prior art wargaming facilities.

In this specification, the terms “comprises”, “comprising” or similar terms are intended to mean a non-exclusive inclusion, such that a method, system or apparatus that comprises a list of elements does not include those elements solely, but may well include other elements not listed.

### SUMMARY OF THE INVENTION

In one form, although it need not be the only or indeed the broadest form, the invention resides in a method of managing tabletop wargame campaign data, said method including the steps of:

registering details of each player's forces and details of a campaign between said forces with a management computer;

exchanging at least some of said details of each player's forces and said campaign between said players;

updating said details of each player's forces and said campaign after each said player has had an opportunity to input information in relation their forces to said management computer;

exchanging said updated details of each player's forces and said campaign between said players; and

advancing a campaign time in one or more discrete time steps until contact between opposing forces is made or a predetermined campaign time is reached.

Preferably, said registering and exchanging steps are carried out via a communications network, said management computer coupled to be in communication with a terminal for each said player via said communications network.

Preferably, one or more events in relation to the players' forces are executed substantially simultaneously in the campaign time.

Preferably, the method further includes the step of calculating an area of influence for each unit of each said force, contact between opposing forces being made when an area of influence of a unit of one force contacts an area of influence of a unit of an opposing force.

Suitably, each area of influence for each said unit is calculated on the basis of a strength of said unit and a category of said unit. Preferably, said area of influence is also calculated on the basis of a formation of said unit.

Suitably, the information input by the player includes one or more of the following: an order to be executed at a current campaign time, an order to be executed at a future campaign time, xy destination coordinates, xy waypoint coordinates, a unit formation, a unit identification, a unit category, an execution time of an order, a campaign objective.

Suitably, the step of updating the details of each player's forces and the campaign includes taking into account a number of rest periods during movement of the players' forces to determine a weariness factor for the players' forces.

Preferably, the method further includes the step of updating the details of each player's forces and the campaign after the players have conducted a tabletop wargame simulating the contact between the opposing forces and have input results of the tabletop wargame to the management computer.

Preferably, a turn in the tabletop wargame has a fixed relationship to the discrete time steps of the campaign time.

In another form, the invention resides in a system for managing campaign data for a tabletop wargame, said system comprising:

a terminal for each player;

a management computer for registering and updating details of each player's forces and details of a campaign between said forces;

means for exchanging details of each player's forces and details of a campaign between said forces between said players and said management computer;

wherein, after each said player has had an opportunity to input information in relation to their forces via their respective terminal and updated details of each player's forces and said campaign have been exchanged between said players, a campaign time is advanced in one or more discrete time steps until contact between opposing forces is made or a predetermined campaign time is reached.

Preferably, the means for exchanging details of each player's forces and the campaign between the players and the management computer is a communications network coupling each player terminal to be in communication with the management computer.

Alternatively, the means for exchanging details of the player's forces and the campaign between the players and the management computer is a storage means.

In a further form, the invention resides in a computer program for managing campaign data for a tabletop wargame, said computer program executing the steps of:

receiving details of each player's forces and details of a campaign between said forces;

updating said details of each player's forces and said campaign after each said player has had an opportunity to input information in relation to their forces; and

advancing a campaign time in one or more discrete time steps until contact between opposing forces is made or a predetermined campaign time is reached.

Preferably, the computer program executes the further step of updating the details of each player's forces and the campaign after the players have conducted a tabletop wargame simulating the contact between opposing forces and have input results of the tabletop wargame.

Preferably, one or more events in relation to said players' forces are executed substantially simultaneously in campaign time.

Preferably, the computer program further executes the step of calculating an area of influence for each unit of each force, contact between opposing forces being made when an area of influence of a unit of one force contacts an area of influence of a unit of an opposing force.

Suitably, the each area of influence for each unit is calculated on the basis of a strength of said unit and a category of said unit. Preferably, said area of influence is also calculated on the basis of a formation of said unit.

Suitably, the information input by the player includes one or more of the following: an order to be executed at a current campaign time, an order to be executed at a future campaign time, xy destination coordinates, xy waypoint coordinates, a unit formation, a unit identification, a unit category, an execution time of an order, a campaign objective.

Preferably, the step of updating the details of each player's forces and the campaign includes taking into account a number of rest periods during movement of the players' forces to determine a weariness factor for the players' forces.

Preferably, a turn in the tabletop wargame has a fixed relationship to the discrete time steps of the campaign time.

In a yet further form, the invention resides in a computer comprising the aforementioned computer program.

Further features of the present invention will become apparent from the following detailed description.

### BRIEF DESCRIPTION OF THE DRAWINGS

To assist in understanding the invention and to enable a person skilled in the art to put the invention into practical effect preferred embodiments of the invention will be described by way of example only with reference to the accompanying drawings, wherein:

FIG. 1 represents an embodiment of the system according to the present invention;

FIG. 2 is a flowchart representing the method steps and elements according to the present invention;

FIG. 3 shows an example of a unit registration file;

FIG. 4 shows the direction of advancement for line and column formations;

FIG. 5 shows the hierarchies and composition categories according to one embodiment of the present invention;

FIG. 6A represents an example of a menu bar displayed to players for playing the wargame simulator of the present invention;

FIG. 6B shows referee options available under the menu bar shown in FIG. 6A;

FIG. 6C shows review options available under the menu bar shown in FIG. 6A;

FIG. 6D shows command and control options available under the menu bar shown in FIG. 6A;

FIG. 7 shows a table of orders according to one embodiment of the present invention;

FIG. 8 is a screenshot of a review screen available under the review unit option shown in FIG. 6C;

FIG. 9 is a screenshot of a coordinate input screen available under the command and control options; and

FIG. 10 is an example of a situation report generated by the present invention.

### DETAILED DESCRIPTION OF THE INVENTION

The aforementioned problems of the prior art are addressed by the present invention, which is a time-based rather than turn-based tabletop wargame campaign data management system, method, apparatus and computer program, which allows the execution of events such as orders to occur simultaneously or substantially simultaneously in game time, so called campaign time. The issuing of orders and scheduling of events by the two players may also occur simultaneously, but the two players may also issue orders and schedule events at different times. The invention deals with the progression of time by the technique of advancing time in small discrete steps. Generally, the advancement of time stops when a unit contacts another unit or a predetermined campaign time event, such as a daily general staff meeting, occurs.

The present invention provides the means for two opposing forces to conduct a campaign allowing military strategy to be employed. The invention allows for units down to squad level to be given orders and then track when and where they contact opposing forces. The contacts are played out physically using the known tabletop rules of the players' choice. The results of the tabletop battle are then fed back into the computer program. In this way the tabletop games can be played with a strategic objective rather than just an isolated exercise in tactics.

The management of units in time and space updates the various units' locations going forward in time. Additionally, a logistical component is included in the present invention requiring the supply of units to be included in the campaign planning. This has been a factor in real military campaigns that is completely omitted from or difficult to include in stand alone tabletop battle games.

The invention provides for map-based campaigns for armies comprising, for example, five detachments or five companies, but can be much larger. The invention can accommodate armies of all one type or a mixture of allies. A campaign is usually objective based running for a finite period of campaign time such as 3 or 4 days.

The invention can take into account both specific objectives as well as the total remaining points of the army. Players 4, 6, who represent the army commanders, may elect not to have objectives, however the campaigns are generally more interesting with objectives. A referee usually determines the objectives of the campaign, with some input from the opposing players. In reality most generals have little say in the objectives of a campaign. An example of a specific objective would be to destroy a communications centre in a particular city or capture and hold a missile defence base. The complementary would be the opposing player's objective.

A predetermined number of objectives may be allowed, each having an associated points allocation. For example, a completed primary objective may earn 5,000 points. A completed secondary objective may earn 2,500 points and a completed tertiary objective may earn 1,500 points. For a victory to be achieved the combined total points must be greater than the opponent by more than a predetermined number of points, such as 1,000 points, otherwise it is considered a draw.

While there is no specific requirement as to army size, the maps provided in the present invention are generally best suited to armies of at least 10,000 points or more. Campaigns can be fought with homogenous or heterogenous detachments.

While the present invention is independent of the rules used for the tabletop battles, it should be noted that for most tabletop battles the horizontal, vertical and time scales are different. For example, the Games Workshop (GW) vertical scale is about 1:45 while the horizontal scale is unknown. However, it is clearly not 1:45 given that most heavy support weapons only have a range of 36″. In order to have a reasonably realistic relationship between the virtual campaign map and the real world tabletop, it is beneficial to work backwards. For example, if an infantry regiment can adequately defend a front line of, for example, 2.4 km, then one can approximate this to a 2000 point GW detachment. Generally a 1,500 point GW detachment can easily defend about 6′ or 1.8 m of tabletop. Hence, the front line that a 2,000 point detachment can cover is a 33% increase on the 1,500 point detachment resulting in 2.4 m. Thus a reasonable horizontal scale for GW is 1:1000.

Regarding time synchronisation, there must be a relationship between the real tabletop time and the campaign time. Typical tabletop rules for each full turn include each player completing their sequence of move, fire and assault, which may represent 3 minutes in campaign time. Hence, in this example, a battle that lasts for 8 turns represents a battle of 24 minutes. Unlike scenario battles, each tabletop baffle in a campaign lasts as long as it takes to reach a decisive point, such as the enemy withdraws or the objective is achieved. Furthermore, in a campaign when many large bodies of troops could potentially engage each other at different geographical locations, the issue of timing becomes critically important. In order to deal with this, the present invention uses discrete time steps. These time steps represent a 1.5 minute interval in real time. Hence, 2 time steps in campaign time equal one full tabletop turn.

When two or more battles must be tracked in different geographical locations but at slightly different times the issue of time synchronization becomes a little more complicated. The present invention handles this by allowing time to progress for 15 minutes after contact allowing units to continue to advance. It should be noted that the campaign time is expressed in ddd:hhmm:ss, where ddd is days, hhmm and ss are hours, minutes and seconds using the 2400 hour clock. In one embodiment, daylight is from 0600 to 1800.

The campaign map is a vital element for the players to study before they register their units and positions. It is recommended that players generally only plot detachments, task forces or larger units on their map. Otherwise, keeping track of squads throughout a campaign will quickly become tedious and the density of information displayed can affect the map clarity. The map can be displayed in both the Review Units or Intelligence Update options described below.

The maps used in the present invention consist of different types of features such as land, sea, rivers, mountains, roads and cities. Some have no effect on the movement of units while others have a major impact. Table 1 below lists how various features may be displayed and their impact:

TABLE 1

| Feature | Display | Movement Impact |
|---|---|---|
| Land | White with brown borders | None |
| Forest | Green polygon | Slows movement |
| Desert | Yellow polygon | None |
| Sea | Cyan | Blocks movement |
| River | Single blue line | None |
| Major river | Double thickness blue line | Slows movement dramati- |
| | | cally |
| Mountain | Small brown polygon | None |
| Mountain range | Large brown polygon | Slows movement dramati- |
| | | cally |
| Road | Single black line | None |
| Town | Small black circle | None |
| City | Black square | None |

In order to have campaigns that have more realistic strategic considerations, the present invention includes the features of supply and logistics. For example, if an enemy force is encircled, after a period of time they will exhaust their ammunition, fuel and food. Hence, they will eventually be unable to fight unless re-supplied, either by breaking out of the encirclement or by a relief force breaking in. It also requires some consideration by players to the deployment of forces to protect the supply base and supply lines.

The present invention assumes that a detachment will have sufficient supplies to last 2 days campaign time after a resupply and that all detachments start the campaign fully supplied. Simplifications may be included to ensure that supplying troops does not become too onerous. A first simplification is that supply is only by land as supply by air can become too complicated. (In any event, history has demonstrated that supplying encircled troops by air has rarely been successful. Hence, this simplification does not hinder the realism of the simulation.) A second simplification is that a supply unit resupplies all of the requirements, such as ammunition, fuel and food.

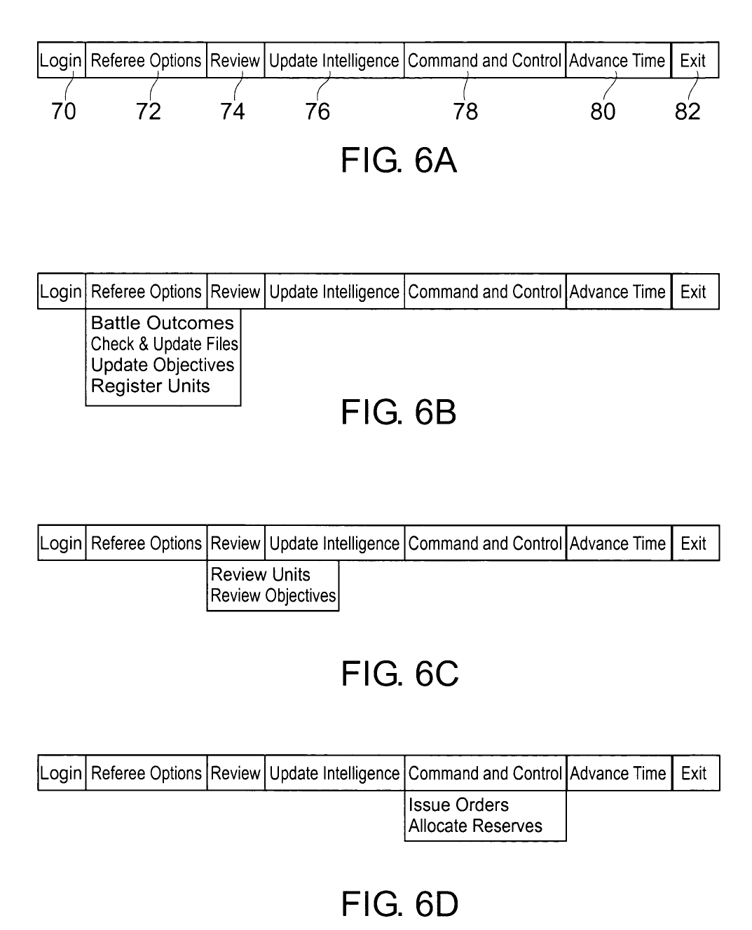

Another important aspect of supply is the replacement of casualties. In the present invention, replacements are considered reserves and arrive at a unit at the time of resupply. However, players must allocate reserves to detachments through the allocate reserves option in the command & control menu shown in FIG. 6D. The program will advise when the reserves have reached a unit. Reserve updates occur at midday (campaign time) during a campaign. This is seen in the number of reserves in the reserve detachment increasing. However, the daily reserve update is around only 10% so the commander must decide if he will replace all the casualties for each unit. This also means that the tabletop commanders must consider how many casualties they are willing to sustain for an objective. The overall commander should also provide some guidance as to the importance of the objective. Securing an objective with only a force reduced to 300 points from 2000 points leaves the force open for a counter attack from a fresh unit that will quickly retake the objective.

Since the present invention is applicable to fantasy wargames involving extra-terrestrial armies and the like as well as conventional terrestrial armies, the present invention caters for the impact of special characters in a campaign, but this is much less than in a 1,500 point tabletop battle. That is because in a campaign army of say five detachments of 2,500 points, each army should only comprise one or two special characters. This is both logical, given the uniqueness of special characters, and consistent with the idea of a campaign, which places more emphasis on strategies and the generalship of units.

When a general is killed in a battle it usually has an adverse impact on the performance of an army. Furthermore, one of the goals of manoeuvre theory is to destroy the opposition's command and control. The present invention simulates this by requiring that every detachment level unit have a HQ Squad 52. If that model is killed, the invention will not allow that unit to be given any new orders until that model is replaced. This simulates the dependence of the detachment level unit on its headquarters such that existing orders or scheduled orders have been planned out, but new plans to meet the demands of new situations cannot be made without a detachment or force commander. Hence even if a detachment or force wins the battle, but the commander is killed, the unit will simply defend its current position.

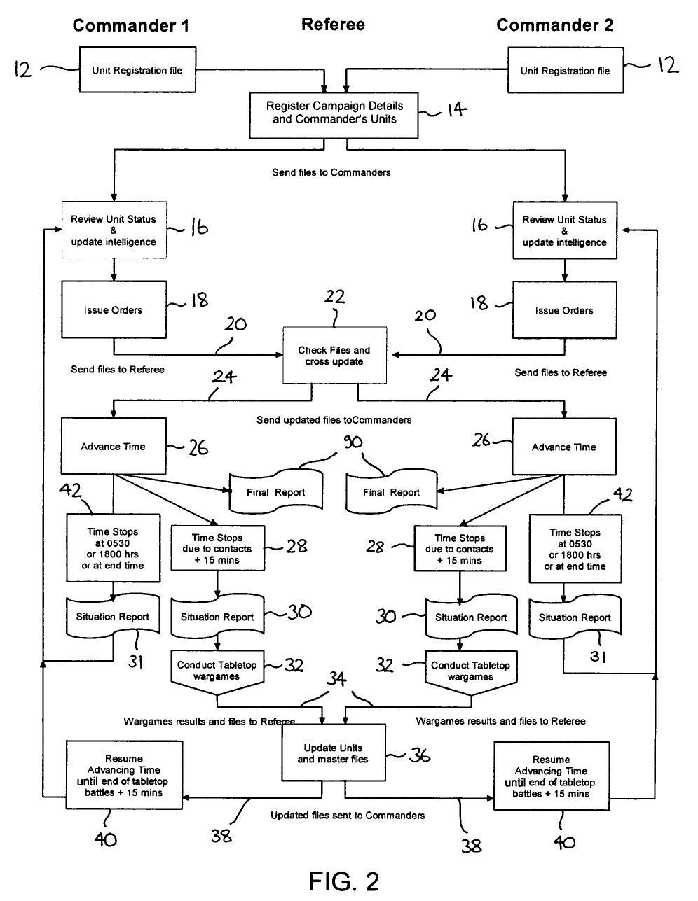

Once a unit is registered, as shown in FIG. 2 and described herein, it can be controlled by the issuance of orders. The program has two types of orders—command orders and standing orders. Standing orders are predefined orders that occur once a unit has met a certain criteria and are automatically issued by the computer program. For example, when two opposing units come into close contact they automatically engage each other. In contrast, command orders are issued by the commanders. Note that the computer program automatically stops the game at predetermined times, such as at 0530 and 1800 hours each day for a general staff meeting at which time unit situations should be reviewed and orders updated. Command orders can be issued at any other break in the campaign remembering that the game cannot be advanced until all of the orders files are transferred to and from the referee. Hence, commanders cannot change their orders too quickly.

At the strategic level orders are simple compared with the tactical level. The orders available to units in the present invention include: Advance, Create Task Force, Assign, Supply, Restock and Retire. The most complicated order is the Advance command, as this order requires a movement route. With reference to FIG. 9, the movement route is determined by providing a destination and a number of waypoints. In addition the player must specify when the movement is to occur and this is specified using the ddd::hhmm:ss format described above. Also the formation for the advance must be specified as either column, the usual, or line.

The supply unit has the task of supplying food, fuel, ammunition and replacement troops to combat units. Hence, if the supply unit is lost early in the campaign it is then unlikely that the army losing its supply unit will win the campaign. While the present invention allows fighting units to be structured with great freedom, it requires that the supply units be structured in a standard format. Again this is done to reduce the logistics planning required with a campaign. Firstly, there must be at least one supply detachment in an army and the army is the governing unit for the supply detachment. A supply detachment consists of a supply base, a HQ squad, a logistics squad and 3 supply squads each of 2 vehicles or transports. Table 2 below shows the troops in the detachment as well as the standard points that should be allocated, which total 1,000 points. For example, the supply base can continuously generate supplies for 36 troop squads of 10 troops.

TABLE 2

| Unit | HQ | Troops | Points |
|---|---|---|---|
| HQ Squad models | 2 | 0 | 120 |
| Logistics Squad | 0 | 5 (included is at least one | 220 |
| models | | forklift or crane) | |
| Supply Squad | 0 | 2 troops and 1 | 220 |
| models | | vehicle/transport | |

The coordinates of the supply base must be entered when the supply detachment is registered. Should a tabletop battle involve a supply base then the following must be present: the HQ squad, the logistics squad, a fuel dump, an ammunition dump and a food/water store. Additionally, the supply squads at the supply dump at that time will also be represented at the tabletop.

As strategic objectives, enemy supply bases can be destroyed. The elements that comprise a supply base contribute equally. Specifically: food/water store 20%, ammunition dump 20%, fuel dump 20%, logistics squad 20% and battalion HQ 20%. Only after all of these elements are destroyed will the supply base be inoperable.

The supply detachment can be given the advance order. This disrupts the supply since at least 6 vehicles are required at the base before it will allow the “Advance” order for the supply detachment. This usually means some supply squads must return to the supply base and be used to move all the stores and logistics to the new location. Therefore, there is no supply during the move. Consequently, supply detachments should be moved as little as possible. They usually do not need to be moved in a short campaign of 3 days or less, but may need to be moved in longer campaigns.

Another feature that enhances the realism of the present invention is that of a unit completely depleting its supplies whilst executing an advance order. If a unit exhausts its supplies during an advance, the computer program will halt the advance and prevent the unit from advancing further until the unit is resupplied. The unit can then be issued with new orders.

Each commander (player 4,6) is allowed a reserve detachment, which holds all of the reinforcements for the entire campaign. The reserve detachment is located in the supply base and does not perform any command and cannot fight. The strength of the reserve detachment is automatically calculated at around 10% of the original army numbers plus or minus some random modification.

Each commander (player 4,6) may then allocate from the reserve detachment to other units that have suffered casualties after each battle. Reinforcing units is done via an Allocate Reserves menu option. The program will then automatically increase the strength of the designated unit when a supply unit next supplies it and decrease the reserve detachment by the same amount until the reserve detachment is exhausted. Note the reserve detachment cannot engage in battle if the supply base is attacked. The reserve detachment simply surrenders if the supply base is destroyed.

Note that simulated continuous day and night movement will greatly affect a unit's weariness. A weariness factor of the present invention attempts to reflect how well troops perform as they become increasingly tired. It also removes the notion of moving troops for 72 hours continuously and then expecting them to fight a battle in peak condition. Consequently astute commanders will generally try to avoid having their units move too long without stopping. The program will advise commanders of the estimated travel time in reaching a specific destination before the order is lodged. Note the travel time does not include delays due to travelling over geographical features such as mountains. The weariness factor for units is determined based on the number of rest periods during a prolonged movement of the units. The higher the weariness factor, the worse troops perform, especially in the areas of marksmanship, hand-to-hand combat and leadership. Exactly how the weariness factor is used in conjunction with the tabletop rules is for the players to decide. However, a guide is shown in Table 3 below using the characteristics of weapons skill (WS), ballistic skill (BS), and leadership (Ld), but other tabletop rules could be adapted in a similar way.

TABLE 3

| Weariness Rating | BS Modifier | WS Modifier | Ld Modifier |
|---|---|---|---|
| 0-Normal | 0 | 0 | 0 |
| 1-Exhausted | −1 | −1 | −1 |
| 2-High Exhaustion | −3 | −3 | −3 |

An example would be a squad that has reached “High Exhaustion” would have their normal BS of 4 reduced to 1, which would severely impact their combat capability. Consequently commanders will need to manage their units in a more realistic fashion for longer duration campaigns.

When units are registered each must have a unique identification and this may be any combination of characters or letters up to a total 30. It is recommended that the players choose some kind of scheme to do this so a unit can be easily identified. Based on the suggested organisational hierarchy of squad, detachment and army, one scheme would be 01/03/5th Marine Army. Here the ‘01’ indicates 1st squad, ‘03’ indicates 3rd detachment in the 5th Marine Army. The program will not know that the 1st Squad is, for example, a Tactical Squad or that the 3rd Detachment is a Crimson Fist Detachment of 2,200 points. This information is retained in the Army List. However, it will know a range of other information essential for running a campaign, such as location at any point in time, unit strength, and other characteristics as described below.

The next item is the points value of the unit. Again this will depend on the tabletop rules used. Also note that since each unit within a detachment has points then the Detachment line cannot have points as the program sums all of the squads to derive the Detachment points.

The structure of the unit being registered is defined. The choices include Squad, Platoon, Company, Battalion, Regiment, Division, Chapter, Corps, Force, Warband, Tribe, Warhost, Detachment and Army.

A unit type is used to determine the speed the unit moves during the campaign.

A supervisory unit is the unit one level above another unit. The usual situation is for Detachments to be supervisory units for Squads and an Army to be the supervisory unit for Detachments.

A unit's composition in the registration file 12 has seven category types: HQ, Elites, Troops, Fast Attack, Heavy Support, Super Heavy Support and Transport.

The position of a unit is provided using an x coordinate and a y coordinate.

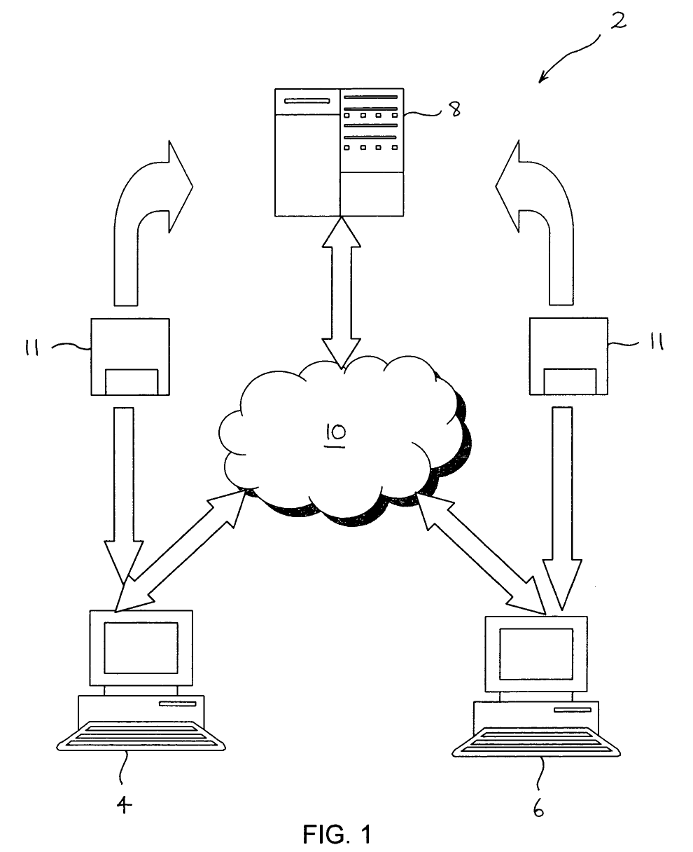

The system 2 of the present invention is shown in FIG. 1 and comprises player terminals 4, 6 coupled to be in communication with a management computer 8 via a communications network 10 The communications network 10 is most likely to be the Internet, but could be a local area network (LAN) or even a wide area network (WAN). Although FIG. 1 shows two player terminals 4, 6, with each player representing an overall commander for each force, it is envisaged that more than two players may participate in the wargame and different commanders may be accommodated. A referee overseas the campaign via the management computer 8 and their role will be described in more detail herein. In an alternative embodiment, the referee function may be provided at the wargame location.

The method steps, information flow and some elements of the present invention are shown in FIG. 2. Each of the players 4, 6, representing commander 1 and commander 2, and the referee has a copy of the computer program of the present invention with key information being exchanged through the transfer of data files via the communications network 8.

Initially the referee registers specific information pertaining to the campaign for which data will be managed via the management computer 8. This information includes: a campaign name, the names of the opposing armies, a map file name, minimum and maximum x and y coordinates representing the battle/conflict area, scoring points for the objectives, game start and end time, the campaign scale, as well as player and referee passwords. This may be done through a utility program, separate from the computer program for managing the campaign data, which creates the master game file. This master game file is encrypted as are all data files holding key unit information such as location and strength. Other data files, such as those for the objectives and unit speeds are created using a text editor and these are not usually encrypted, although they may be encrypted if required.

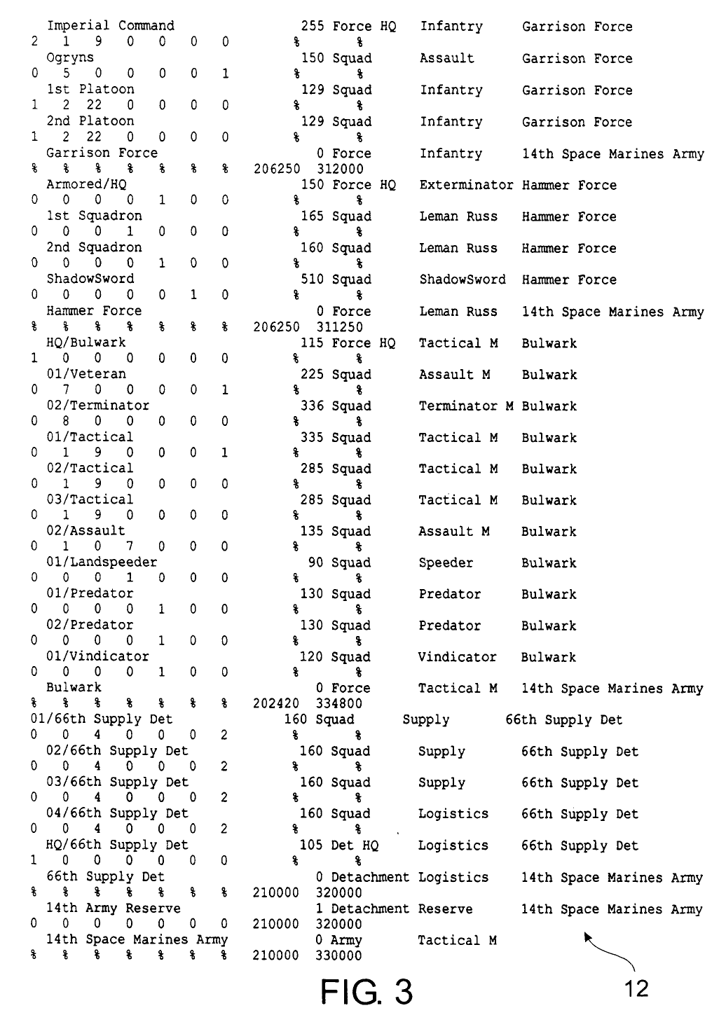

The referee must then register the player's units into the computer program via the management computer 8, as represented by step 14. A sample unit registration file 12 is shown in FIG. 3. The information required in the registration file includes: unit name, unit class, unit type, supervisory unit name, strength in each troop and equipment category, and starting unit locations. The % symbol is a special value, which is used to indicate that the values are derived from a related hierarchical unit. For example, if a squad level unit has % for xy coordinates, then it uses the xy coordinates of its supervisory unit. Also all detachment level units will have % for their strength in the troop categories as they derive their strength from all of their subordinate units at the squad level.

Two special unit types are mandatory. These are a supply unit, for resupplying units, and a reserve unit, which will hold the reinforcements of each category. The computer program in the management computer 8 checks the data in the unit registration files 12 before the information is logged into the campaign data files. If errors have been made it will reject the registration file and produce an error report. The error report can be inspected and the errors corrected allowing the unit registration file 12 to be successfully loaded into the computer program. Once this is successfully loaded, the computer program automatically generates the remaining data files required in encrypted format. At the time of loading the unit registration file 12 the computer program also calculates daily reinforcement levels. The levels are randomly calculated in the range of 14% to 18%. The newly created campaign data files are then transferred to the players 4, 6, via the communications network 10, e.g. by email. Alternatively, the newly created campaign data files may be physically transferred to the players 4, 6 on storage means 11, such as a CD or floppy disk.

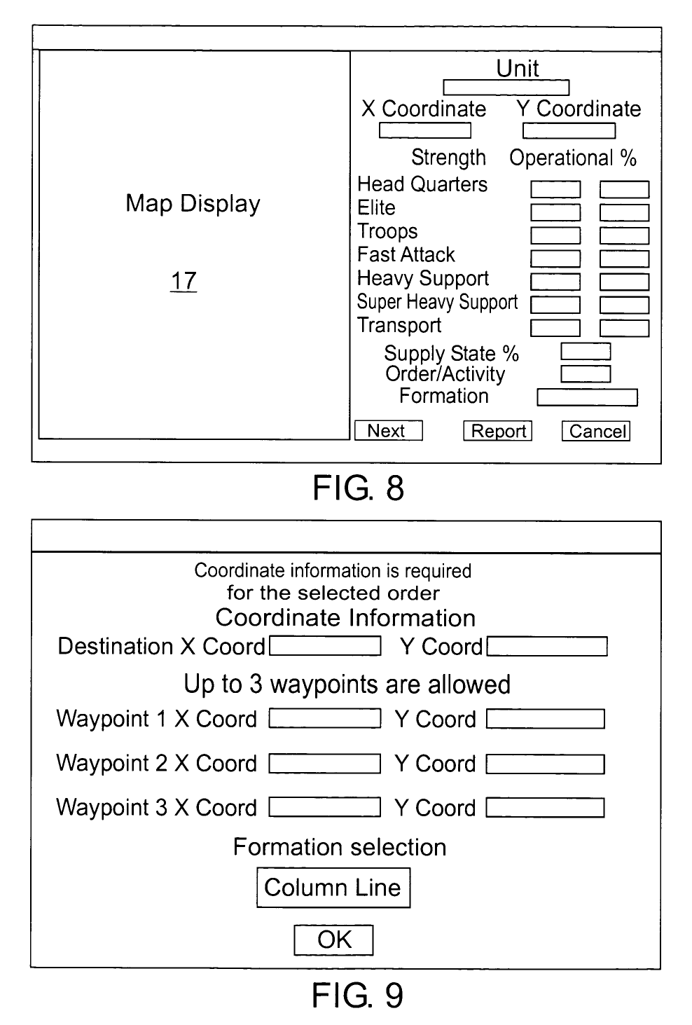

The players 4, 6 can then review the status, the strength and supply levels, as well as the location of their units on the map representing the battle zone, as represented by steps 16. In addition players must update the computer program with the coordinates of the area occupied by the enemy. This is done by pointing and clicking with the computer mouse on the campaign map display 17 displayed on the computer screen, as represented in FIG. 8. The map display 17 shows friendly forces as, for example, solid blue rectangles along with the key geographical features such as cities, roads, rivers, mountains, forests, seas and the like in appropriate colours as well as the enemy occupied zone outlined in red. Another feature is the ability to locate enemy units on the map display 17. These are shown, for example, as red rectangles. The map can be displayed with the names of, for example, cities, units and other features either shown or not shown as desired by each player. This is useful depending on the congestion of the map display.

Another feature of this section of the computer program is the ability to graphically plot out the route of a unit's advance. After entering the unit's name, the friendly units are displayed. The selected unit may be shown in solid blue while other friendly units may be, for example, displayed with the rectangle outline in blue. With reference to FIG. 9, the player then simply points and clicks with up to three waypoints and the final destination to define the route of advance. This information can be saved or more unit's routes may be defined and then saved. This saved information automatically populates the coordinate information required for those units when the orders are issued in another section of the computer program as described below.

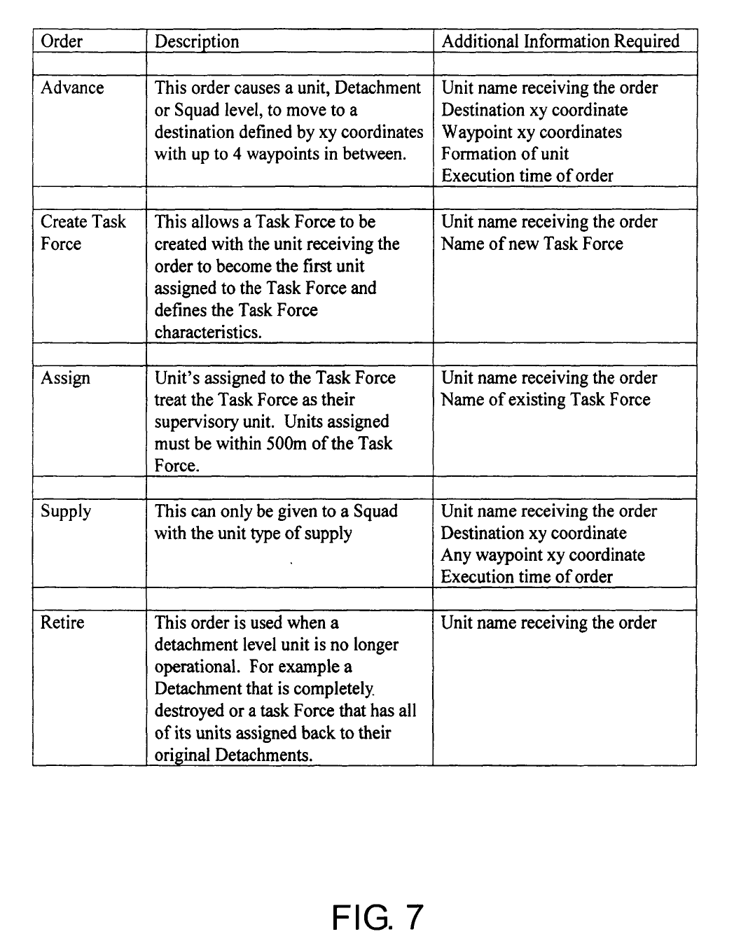

Once the players 4, 6 have studied the map and determined how they will deploy their units, they can issue orders as represented in steps 18. This section of the computer program allows a variety of orders to be issued. The table shown in FIG. 7 shows an example of a list of valid orders and their associated description that may be issued to each unit.

Another feature linked with issuing orders is the ability to schedule when an order is to be executed. While the default option for the execution of orders is the current campaign time, orders may be set to occur at a future campaign time allowing the movement and arrival of units to occur in a coordinated or synchronized fashion. This key strategic feature is not possible in the turn based prior art wargames software.

Once all the orders have been issued, with reference to steps 20, the players 4, 6, transfer their data files to the referee via the communications network 8 or physically as described above. With reference to step 22, the referee checks the data files using the computer program and sends a fully updated set to each player 4, 6, as represented by steps 24. At this point the players can perform all of the usual operations except for issuing new orders. However, the players 4, 6, must advance the campaign time, as represented by steps 26, which is done by incrementing time in small discrete time steps.

After each discrete time step the computer program updates the location of any moving unit by the distance covered in that time step and checks for contacts between units both allied and hostile. If contact between an allied and hostile unit occurs, the time progression is advanced, for example, for only 10 more discrete time steps before time progression stops, as represented by steps 28. This allows the location of other units to be updated while the engaged allied and hostile units are locked in their battle before the time progression stops. It also assists with the determination of closely timed multiple contacts between allied and hostile units.

Referring to steps 30, the invention then updates a situation report file and issues a situation report that can be inspected by the players 4, 6 and the referee, once time progression stops. This is used to determine which tabletop wargames physically need to be conducted by the players. The information needed to determine the strength and condition of the forces involved in the contacts can be obtained from the review section of the computer program.

Once the tabletop wargames have physically been conducted, as represented by steps 32, using agreed, known tabletop wargame rules, the players 4,6, must carefully note the results. The information noted includes casualty numbers and the number of tabletop turns. This is then translated into campaign minutes. For example, usually one turn for each player equates to 3 campaign minutes.

Referring to steps 34, the updated data files from each player are sent to the referee via the communications network 8 or physically on a storage media along with the results of the real world tabletop wargames. Once the results, casualties and the victory or defeat status of the engaged units have been entered into the computer program by the referee and updated, as represented by step 36, the updated data files are then sent back to the players, as represented by steps 38. At this stage the computer program will only allow time to advance. It does this in steps 40 for each player for a period of time equal to the longest tabletop battle performed in steps 32 plus a predetermined time period, such as 15 minutes. After time has been advanced in this way, the players 4, 6 return to steps 16 and issue new orders.

Another unique feature of the invention is that if the detachment level headquarters' command models are all casualties then no new order can be issued to the detachment until at least one command model is replaced through reinforcements.

With reference to steps 42, the computer program also stops at, predetermined times, such as 0600 and 1800 hours campaign time each day to allow the situation of units to be reviewed and new orders issued at steps 16. A situation report 31 is generated to facilitate this. The computer program allows orders to be issued at the commencement of the campaign and at any point the computer program stops advancing the time. However, contacted units or units engaged in battle, as represented by steps 28, will not respond to new orders, until their battle has been resolved by a physical tabletop wargame, as shown at steps 32.

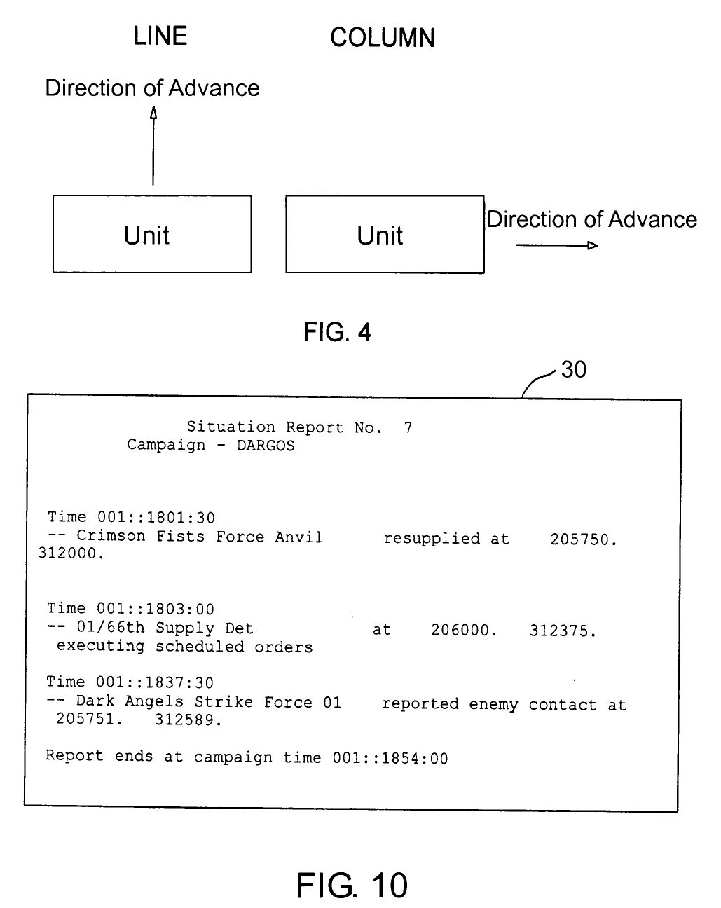

The invention allows units to be moved and have positions defined in xy coordinates, rather than employing the limiting grid cell method of some of the prior art. It achieves this by calculating an Area of Influence (AOI) for each unit based on the strength of the unit and the category of the unit. Preferably, the formation of the unit is also considered when calculating the Area of Influence. It then uses the centre of the unit for movement calculations, but includes the corners of the AOI for contact calculations. With reference to FIG. 4, the invention allows two types of formations, line formations and column formations, which have the associated directions of advancement as shown in FIG. 4.

The tabletop deployments for the two formations are different reflecting the shape of real units in battle. The column deployment zone on a tabletop is a 30″×30″ (750 mm×750 mm) square with one side on the table edge, in which 25% of the detachment must be deployed. This occurs at the beginning of the tabletop battle and is usually centred on the line of advance, which is often a road. In the following turn a further 50% may be deployed any where on the table edge and the remaining 25% can be deployed the next turn again anywhere on the table edge. A Line deployment zone is 18″ along one entire table edge in which 50% of the unit must be placed. In each of the following turns 25% may be deployed.

Detachment units may be deployed in any category order. If one player is in line formation inside a city or town they may increase their deployment zone to 30″. If a column formation meets a line formation then the players must use the shortest table edge for their deployment zone. Player may hold those portions of the detachments not deployed at the beginning of a tabletop battle in reserve for the whole game. This is to conceal the strength of their detachment or preserve forces for later engagements. Infiltrators, scouts etc., are only allowed to have one extra move, after they have been deployed, and before the game starts. The distance they can be moved for this is the total of 2D6 die. No special infiltration behind enemy lines is allowed. Standard tabletop rules apply for hidden set-up, night fighting, obstacles, fortifications and preliminary bombardment.

Due to the way the invention's data structures are designed, the present invention accommodates numerous levels of unit hierarchy. Hence, a unit and its supervisory unit in an army can be controlled as one entity or as separate entities, regardless of the wargaming rules used for the real tabletop battles. However, the invention is designed to be compatible with most common tabletop wargaming rules, especially regarding unit composition.

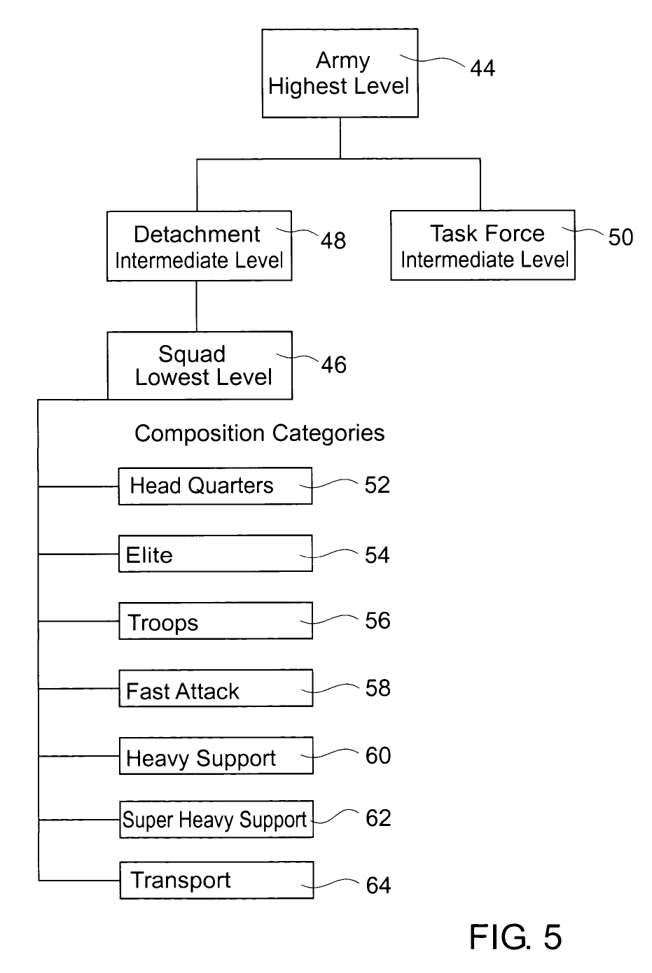

According to one embodiment, the present invention comprises seven (7) composition categories, which are represented in FIG. 5 along with the hierarchical relationships. The army 44 is the highest level unit organisation and the lowest level is the squad 46. Hence, one could fight a campaign with a large number of squads 46 all belonging to an army 44. However, if a large number of squads 46 are used, e.g. more than 20, the management and control of the squads will become very demanding. Consequently, one extra hierarchical level can be placed between squad level and army level, which is often refereed to as the detachment level 48. Note that a task force 50 can be constructed from units in other detachments by assigning them to the task force. This accurately reflects the creation of task forces in reality.

The registration of an army composition is via, for example, a text file with another file for the unit categories and their speed. Since a detachment must have a category, by default it therefore has an associated speed. These files should be saved as they can be used, perhaps with some modifications, for other campaigns.

The present invention allows orders to be given at every level of hierarchy below army level 44. Unless a unit is assigned to another supervisory unit or issued an order at its level then it will carry out the orders of the supervisory unit, usually the detachment 48. For example, if a detachment 48 consisted of nine squads 46 and orders were given to the detachment 48 to move to a specified location, but another order was given to one of the squads 46 to defend the current location, the order for the detachment 48 would only effect the other eight squads.

When units are registered as described above their hierarchy must be provided, along with their unit type, unit category, as well as numbers in each squad category. With reference to FIG. 5, the squad categories include HQ 52, Elite 54, Troop (Men) 56, Fast Attack 58, Heavy Support 60, Super Heavy Support 62 and Transport 64. The management computer 8 does not hold any details about the models, apart from their unit category and speed. For example, a Space Marine HQ Squad, which consists of a Commander and Chaplain, would only be listed as a HQ Squad of 2. Specific details about the HQ Squad would be retained in the Army List for that detachment which still should be presented at the time of a real tabletop battle.

While existing products offer some capability to include the issue of supply, the present invention does it in a more complete fashion. It uses a supply base and a number of specialist supply units that must be directed to combat units. Furthermore, at the time of resupply units can also receive reinforcements, a feature not present in other products.

The computer program provides seven menu options once the players/referee have entered their username and password. Should one of the players succeed in guessing the others password to view their unit information the referee will be able to determine if such a breach has occurred. In one embodiment, six options are available to the players 4, 6 while the seventh is only accessible to the referee. With reference to FIG. 6A, the menu options are: Login 70, Referee Options 72, Review 74, Update Intelligence 76, Command and Control 78, Advance Time 80 and Exit 82. The main menu bar with some of the sub-options is shown in FIGS. 6B-6D. Hence, for a person familiar with the basics of computers, the present invention is easy to use.

A Review Units sub-option available through the Review option 74 will display detailed information about each detachment level unit, including their current location on the map 17, as shown in FIG. 8. The NEXT button displays the next unit in the detachment while the REPORT button writes the information to a file. The Review Objectives sub-option available through the Review option 74 gives a view of the objectives, associated points, status, the current army points and the total points at that time.

The Update Intelligence option 76 should be used extensively by the players 4, 6, to develop their plans and determine movement routes for their units. Each commander should construct an enemy polygon based on whatever intelligence they can gather. The enemy polygon should be maintained as this determines the orientation of a Commander's units, i.e. the direction a unit faces to the enemy front line or boundary. The enemy polygon also aids each commander to appreciate graphically the extent of enemy occupied territory.

The Issue Orders sub-option available through the Command and Control option 78 has several dialogue screens the Commanders must understand. Orders can be issued at any time the campaign is not in the advance time phase, i.e. when the data files are being exchanged. Orders issued in between sending files to the management computer 8 and receiving them back will not have any effect. All orders and the allocation of reserves must occur before the files are exchanged.

Coordinate information is required for Advance or Supply options. However, the coordinate information for Advance is automatically populated if the Advance Unit Planner option was used and the information saved. Coordinates may be entered via the input screen shown in FIG. 9.

Only the name of the Task Force is required with the Create Task Force option, because the unit name entered for the order will become the core unit of the Task Force.

The Allocate Reinforcements Sub-option requires the name of the unit to be reinforced to be entered.

The current actual strength for the sub-units of the reinforced unit is displayed along with the allowable reinforcements and the available reinforcements. A commander cannot allocate more troops in a category that is greater than the number that was originally registered.

The exit option shown in FIGS. 6A-6D allows a player to exit the program, usually to exchange data files or conduct a physical tabletop wargame.

The present invention generates 3 types of reports. The situation report 30 (shown in FIG. 2), is automatically generated for each player at the end of each advance time phase. It provides information about units executing scheduled orders, arriving at destinations, running low on supplies and contacting the enemy. It may be a text file and the file name may be in the format Cx_REP0n.TXT, where x is either 1 or 2 to denote a report for Commander1 or Commander2. The n indicates which report in the sequence of reports where the highest n is the most recent. The commanders can also generate a report from the Review Units sub-option. This contains the same information shown on the screen for the current unit.

FIG. 10 shows an example of a situation report 30 stating that the Crimson Fists Anvil Force has been resupplied on the second day of the campaign at 1800 hrs plus 1 minute and 30 seconds at coordinates (205,750, 312,000). It also shows that a Supply Squad began to execute a new command at 1800 hrs plus 3 minutes. It did this from coordinates (206,000, 312,375). The most important information is the enemy contact that the Dark Angels Strike Force makes at coordinates (205,751, 312,589) at 1800 hrs 37 minutes and 30 seconds. Note that the report was not generated until approximately 15 minutes later. Also note this is the 7^{th} Situation Report for the Dargos campaign.

A final report 90 is generated at the end of the game once the allocated game time has elapsed, which calculates the points total of both armies. The unit points are calculated using the percentage of the surviving models in the unit by the base points of the unit. Hence a Veteran Sergeant would have an equal weight in contributing to the campaign unit points as a standard trooper. This is to reduce the effects of an army loaded with special characters and to skew the results in favour of better leadership of units by the players 4, 6.

The present invention thus provides a solution to the aforementioned problems of the prior art by providing a time-based wargame data management facility that increments time in discrete steps, rather than the limiting turn-based method. Hierarchies may be represented by the present invention and the players enter details of the multiple units, detachments and task forces and the like. All the characteristics of the units and their movements and the like are modelled by the present invention enabling realistic simulations to be enjoyed. The realism of the simulation is enhanced by the consideration of important factors such as supply and logistics, weariness, order scheduling and synchronisation. Once contact between opposing forces is made, the ensuing wargame is physically played out by the players, with the results of the wargame including battle time and casualties being fed back into the system.

Throughout the specification the aim has been to describe the invention without limiting the invention to any one embodiment or specific collection of features. Persons skilled in the relevant art may realize variations from the specific embodiments that will nonetheless fall within the scope of the invention.

1. A method of managing tabletop wargame campaign data, said method including the steps of:
registering details of each player's forces and details of a campaign between said forces with a management computer;
exchanging at least some of said details of each player's forces and said campaign between said players;
updating said details of each player's forces and said campaign after each said player has had an opportunity to input information in relation their forces to said management computer;
exchanging said updated details of each player's forces and said campaign between said players; and
advancing a campaign time in one or more discrete time steps until contact between opposing forces is made or a predetermined campaign time is reached.

2. The method of claim 1, wherein said registering and exchanging steps are carried out via a communications network, said management computer coupled to be in communication with a terminal for each said player via said communications network.

3. The method of claim 1, wherein one or more events in relation to said players' forces are executed substantially simultaneously in said campaign time.

4. The method of claim 1, further including the step of calculating an area of influence for each unit of each said force, contact between opposing forces being made when an area of influence of a unit of one force contacts an area of influence of a unit of an opposing force.

5. The method of claim 4, wherein each said area of influence for each said unit is calculated on the basis of a strength of said unit and a category of said unit.

6. The method of claim 4, wherein each said area of influence for each said unit is calculated on the basis of a strength of said unit, a category of said unit and a formation of said unit.

7. The method of claim 1, wherein said information input by said player includes one or more of the following: an order to be executed at a current campaign time, an order to be executed at a future campaign time, xy destination coordinates, xy waypoint coordinates, a unit formation, a unit identification, a unit category, an execution time of an order, a campaign objective.

8. The method of claim 1, wherein the step of updating said details of each player's forces and said campaign includes taking into account a number of rest periods during movement of said players' forces to determine a weariness factor for said players' forces.

9. The method of claim 1, further including the step of updating said details of each player's forces and said campaign after said players have conducted a tabletop wargame simulating said contact between said opposing forces and have input results of said tabletop wargame to said management computer.

10. The method of claim 1, wherein a turn in said tabletop wargame has a fixed relationship to said discrete time steps of said campaign time.

11. A system for managing campaign data for a tabletop wargame, said system comprising:
a terminal for each player;
a management computer for registering and updating details of each player's forces and details of a campaign between said forces;
means for exchanging details of each player's forces and details of a campaign between said forces between said players and said management computer;
wherein, after each said player has had an opportunity to input information in relation to their forces via their respective terminal and updated details of each player's forces and said campaign have been exchanged between said players, a campaign time is advanced in one or more discrete time steps until contact between opposing forces is made or a predetermined campaign time is reached.

12. The system of claim 11, wherein said means for exchanging details of each player's forces and said campaign between said players and said management computer is a communications network coupling each said player terminal to be in communication with said management computer.

13. The system of claim 11, wherein said means for exchanging details of each player's forces and said campaign between said players and said management computer is a storage means.

14. A computer program for managing campaign data for a tabletop wargame, said computer program executing the steps of:
receiving details of each player's forces and details of a campaign between said forces;
updating said details of each player's forces and said campaign after each said player has had an opportunity to input information in relation to their forces; and
advancing a campaign time in one or more discrete time steps until contact between opposing forces is made or a predetermined campaign time is reached.

15. The computer program of claim 14, executing the further step of updating said details of each player's forces and said campaign after said players have conducted a tabletop wargame simulating said contact between opposing forces and have input results of said tabletop wargame.

16. The computer program of claim 14, wherein one or more events in relation to said players' forces are executed substantially simultaneously in campaign time.

17. The computer program claim 14, further executing the step of calculating an area of influence for each unit of each said force, contact between opposing forces being made when an area of influence of a unit of one force contacts an area of influence of a unit of an opposing force.

18. The computer program of claim 17, wherein each said area of influence for each said unit is calculated on the basis of a strength of said unit and a category of said unit.

19. The computer program of claim 17, wherein each said area of influence for each said unit is calculated on the basis of a strength of said unit, a category of said unit and a formation of said unit.

20. The computer program of claim 14, wherein said information input by said player includes one or more of the following: an order to be executed at a current campaign time, an order to be executed at a future campaign time, xy destination coordinates, xy waypoint coordinates, a unit formation, a unit identification, a unit category, an execution time of an order, a campaign objective.

21. The computer program of claim 14, wherein the step of updating said details of each player's forces and said campaign includes taking into account a number of rest periods during movement of said players' forces to determine a weariness factor for said players' forces.

22. The computer program of claim 14, wherein a turn in said tabletop wargame has a fixed relationship to said discrete time steps of said campaign time.
